(19) United States
(12) Patent Application Publication
(10) Pub. No.: US 2012/0111378 A1
(43) Pub. Date: May 10, 2012

(54) HIGH PRESSURE HOSE

(75) Inventor: Roy F. Brow, Oconomowoc, WI (US)

(73) Assignee: Briggs & Stratton Corporation

(21) Appl. No.: 13/099,238

(22) Filed: May 2, 2011

Related U.S. Application Data
(60) Provisional application No. 61/410,307, filed on Nov. 4, 2010.

(51) Int. Cl. F16L 55/00; B29C 47/12; B08B 3/02

(52) U.S. Cl. 134/174; 138/36; 239/373; 264/177.1

(57) ABSTRACT

A hose includes a reinforcement structure and a layer exterior to the reinforcement structure. The layer includes a plurality of extensions projecting outwardly. Wear of the plurality of extensions provides a visual indication of the degree of wear of the hose.

### CROSS-REFERENCE TO RELATED PATENT APPLICATIONS

This application claims the benefit of U.S. Provisional Application No. 61/410,307, filed Nov. 4, 2010, which is incorporated herein by reference in its entirety.

### BACKGROUND

The present application relates to a hose, such as a hose designed for use with a high-pressure water flow of a pressure washer.

A pressure washer typically includes a high pressure hose or line extending between a pump and a spray gun of the pressure washer. Another hose, such as a standard garden hose, supplies water to the pump. During operation, an engine or other motor of the pressure washer drives the pump, which pressurizes water received from the garden hose and provides the water to the high pressure hose and the spray gun.

Some pressure washers are configured to provide water at pressures exceeding 2000 pounds per square inch (psi), and the high pressure hose between the pump and gun is designed to withstand such pressures without rupturing. Accordingly, some pressure washer hoses include a mesh of strengthening members to reinforce the hose. The strengthening members may be embedded within walls of the hose, and may be integrated in a matrix of plastic or other material forming the walls of the hose.

Over time a pressure washer hose may be pulled over a broad range of abrasive surfaces, such as asphalt, cement, or rocks hose, and may become worn. Eventually, the outer surface of the hose may be removed, exposing the mesh of strengthening members. The exposed strengthening members may slide against abrasive surfaces, one another, and the remaining layers of the hose, further weakening the hose as well as the strengthening members themselves. However, the degree of wear of the hose may be difficult to ascertain at first glance.

### SUMMARY

One embodiment of the invention relates to a hose. The hose includes a reinforcement structure and a layer exterior to the reinforcement structure. The layer includes a plurality of extensions projecting outwardly. Wear of the plurality of extensions provides a visual indication of the degree of wear of the hose.

Another embodiment of the invention relates to a pressure washer, which includes a pump, a spray gun, and a hose configured to connect the spray gun to the pump. The hose includes a plurality of extensions projecting outwardly from the hose. Wear of the plurality of extensions provides a visual indication of the degree of wear of the hose.

Still another embodiment of the invention relates to a method of manufacturing a hose. The method includes providing an extrusion die, and extruding a layer of a hose using the extrusion die. The layer includes a plurality of extensions projecting outwardly. Wear of the plurality of extensions provides a visual indication of the degree of wear of the hose.

Alternative exemplary embodiments relate to other features and combinations of features as may be generally recited in the claims.

### BRIEF DESCRIPTION OF THE FIGURES

The disclosure will become more fully understood from the following detailed description, taken in conjunction with the accompanying figures, in which:

FIG. 1 is a perspective view of a pressure washer according to an exemplary embodiment of the invention.

FIG. 2 is a perspective view of a hose for the pressure washer of FIG. 1.

FIG. 3 is cut-away perspective view of a section of a hose according to an exemplary embodiment of the invention.

FIG. 4 is a sectional view of a layer of a hose according to an exemplary embodiment of the invention.

FIG. 5 is a sectional view of the outer layer of FIG. 4 with a portion removed.

FIG. 6 is a front view of a hose and an extrusion die according to an exemplary embodiment of the invention.

FIG. 7 is a sectional view of a layer of a hose according to an exemplary embodiment.

FIGS. 8-10 are perspective views of layers of hoses according to other exemplary embodiments of the invention.

FIGS. 11-12 are side views of hoses according to still other exemplary embodiments of the invention.

FIGS. 13-14 are sectional views of hoses according to other exemplary embodiments of the invention.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

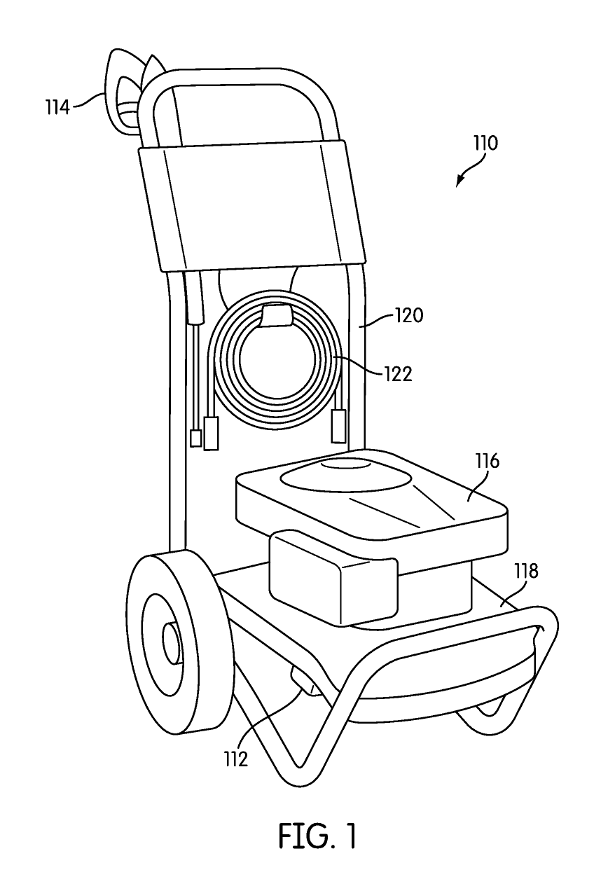

Referring to FIG. 1, a pressure washer 110 includes a high pressure water pump 112, such as an axial cam or triplex water pump, and a spray gun 114 (e.g., sprayer, wand). In some embodiments, the pump 112 is driven by an internal combustion engine 116 mounted to a base plate 118 on a frame 120 above the pump 112. The pump 112 is designed to receive water from a standard garden hose (not shown), pressurize the water (e.g., from about 60 psi to over 1000 psi), and supply the pressurized water to a high pressure hose 122 connected to the spray gun 114. The hose 122 may be coiled and stored on the frame 120 and the gun 114 may also be stored on the frame 120, as shown in FIG. 1. In some contemplated embodiments, a horizontally-shafted engine may be coupled to a pump on the same side of a base plate. In other contemplated embodiments, an electric motor may be used to drive the pump.

According to an exemplary embodiment, the pressure washer 110 is designed to help clean dirt, paint, or mold from pavement, brick face, or other surfaces. To achieve such results, the pressure washer 110 is configured to provide a stream of water at a high pressure, such as approximately 2000 to 3000 psi. In some contemplated embodiments, a heavy-duty pressure washer is configured to provide streams with even higher pressures, such as about 3000 to 5000 psi, and may be designed to perform other tasks, such as resurfacing or cutting of materials that require extremely powerful flows. Accordingly, high-pressure hose lines and spray guns are designed to operate under the pressures associated with such heavy-duty pressure washers.

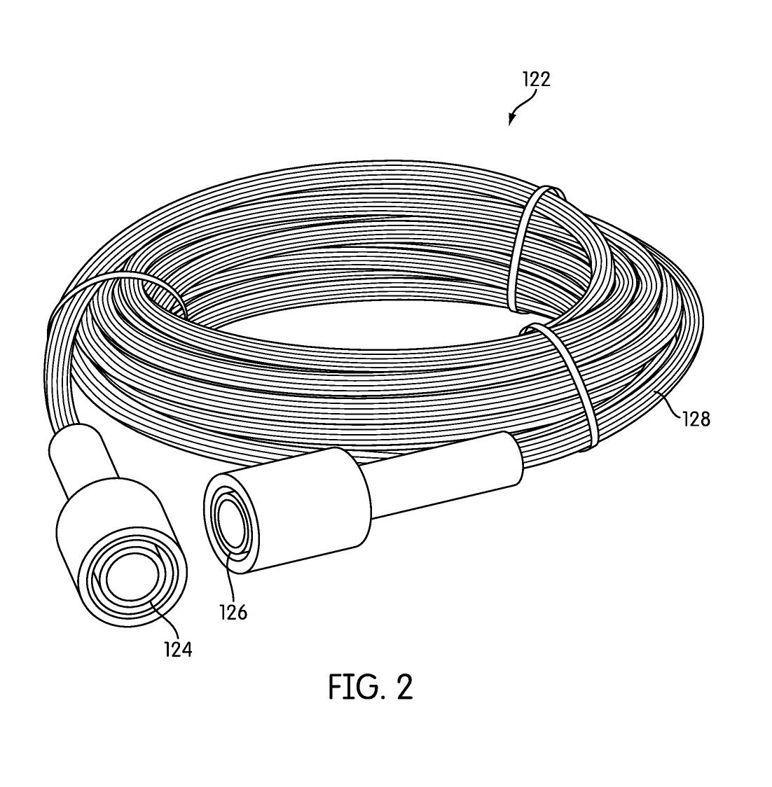

Referring to FIG. 2, the pressure washer hose 122 includes a first fitting 124 to be coupled to an outlet of the high pressure water pump 112 and a second fitting 126 to be coupled to an inlet of the water gun 114. The fittings 124, 126 may include quick connect fittings, threaded fittings, or other types of connectors. Extending between the fittings 124, 126, the hose 122 includes an elongate body 128 (e.g., conduit), which may exceed ten feet in length. In some embodiments, the fittings 124, 126 and body 128 are configured to withstand the operating pressures of the pressure washer 110, as well as trapped pressures between the gun 114 and pump 112 when the gun 114 is not spraying but the pump 112 is still active (e.g., increasing the pressure by about 100-400 psi above the operating pressures). Such pressures may exceed 2000 psi. In other embodiments, pumps include flow-activated unloaders that do not have trapped-line pressure.

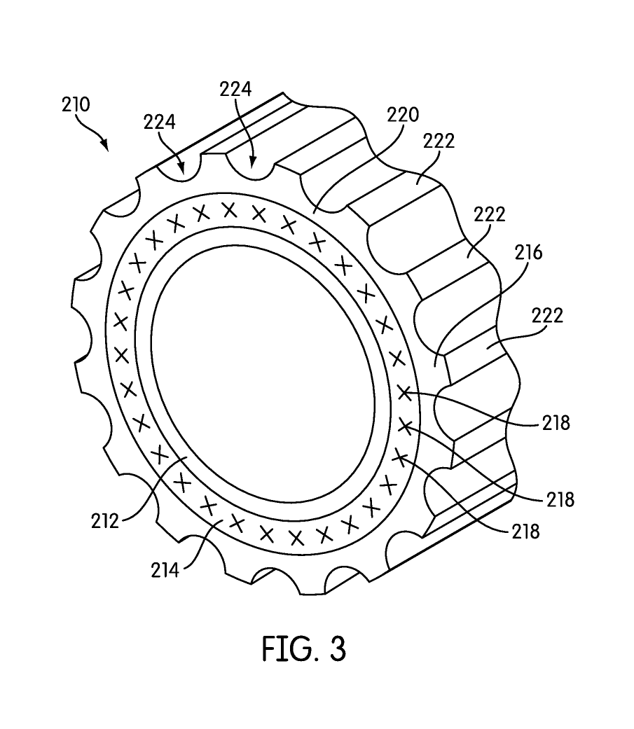

Referring to FIG. 3, a hose 210, such as a pressure washer hose, includes an inner layer 212 (e.g., core), a reinforced layer 214 (e.g., support layer, middle layer, reinforcement structure), and an outer layer 216 (e.g., outer jacket). In some embodiments, the inner layer 212 is formed via extrusion of a thermoplastic or rubber, and the reinforced layer 214 includes a mesh of strengthening members 218 (e.g., weave, fabric, cross-ply), such as metal fibers (e.g., steel) or fibers used with continuous or discontinuous fiber composites (e.g., nylon webbing, carbon fibers, Kevlar, etc.). The mesh of strengthening members 218 may be integrated in a matrix of thermoplastic, resin, or other material, or may fully form the reinforced layer 214. In other embodiments, the hose does not include a reinforcement layer and/or inner layer. According to an exemplary embodiment, the outer layer 216 is formed via extrusion of a thermoplastic or rubber, and in some embodiments is formed from the same material as the inner layer.

Wearing of the outer layer 216 may expose the mesh of strengthening members 218 of the reinforced layer 214. Exposure of the mesh of strengthening members 218 of the reinforced layer 214 may allow for movement of different strengthening members relative to one another, or may allow for direct contact between the mesh of strengthening members 218 of the reinforced layer 214 and the ground or other surfaces, which may hasten wear of the mesh of strengthening members 218 and the hose 210 in general. As such, exposure of the mesh of strengthening members 218 of the reinforced layer 214 may eventually lead to failure of the hose 210.

According to an exemplary embodiment, the outer layer 216 includes an annular portion 220 that is adjacent to the reinforced layer 214. Extensions 222 (e.g., wear bars, indicators) project from the annular portion 220 of the outer layer 216. In some embodiments, the extensions 222 are uniformly sized and are spaced around the periphery of the outer layer 216. The extensions 222 may project from the annular portion 220 by a distance that is at least a sixteenth of an inch (e.g., an eighth of an inch). In some embodiments, the hose 210 further includes grooves 224 formed between the extensions 222. In other embodiments, the extensions 222 may project from the annular portion 220 by a distance that is less than a sixteenth of an inch, such as at least a thirty-second or sixty-fourth of an inch.

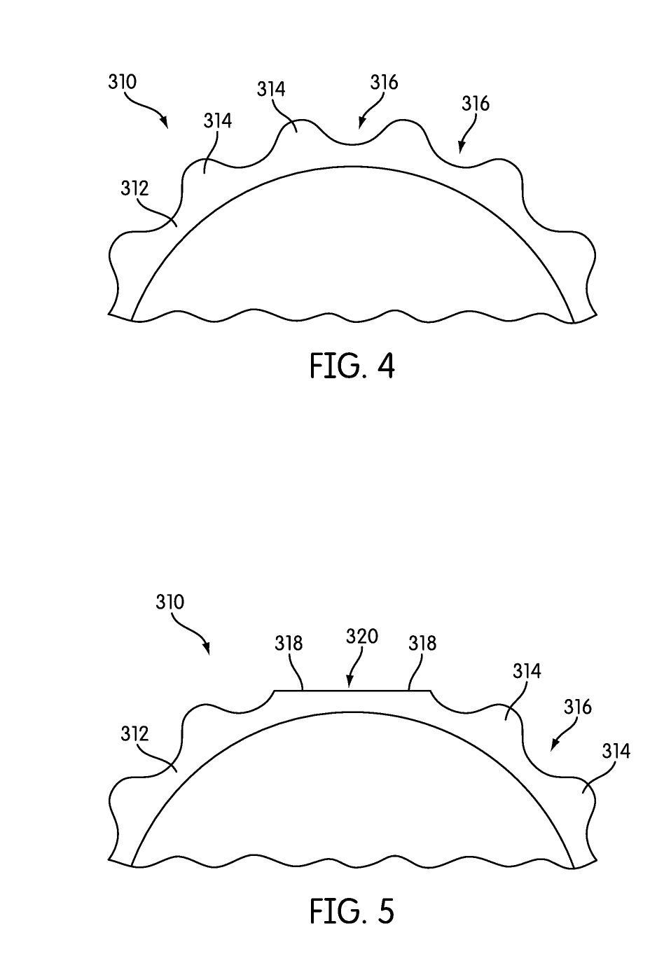

Referring to FIGS. 4-5, layer 312 of a hose 310 includes extensions 314 and grooves 316. Wearing of the extensions 314 provides a visual indication of the degree of wear of the layer 312. Upon visual inspection of the hose 310, wear of the extensions 314 may be shown with reference to the grooves 316. As the extensions 314 wear, in some embodiments the extensions 314 get wider and eventually merge to be level with adjacent grooves 316. Accordingly, the extensions 314 may provide an operator of a pressure washer (see, e.g., pressure washer 110 as shown in FIG. 1) the ability to quickly inspect the integrity of the pressure washer hose (see, e.g., hose 122 as shown in FIG. 2). When the extensions 314 are sufficiently worn, such as when extensions 318 (FIG. 5) on a portion of the hose tend to merge or have merged with the adjacent grooves 320 (FIG. 5), then the state of the extensions 318 provides notice to the operator that the hose 310 may need to be replaced.

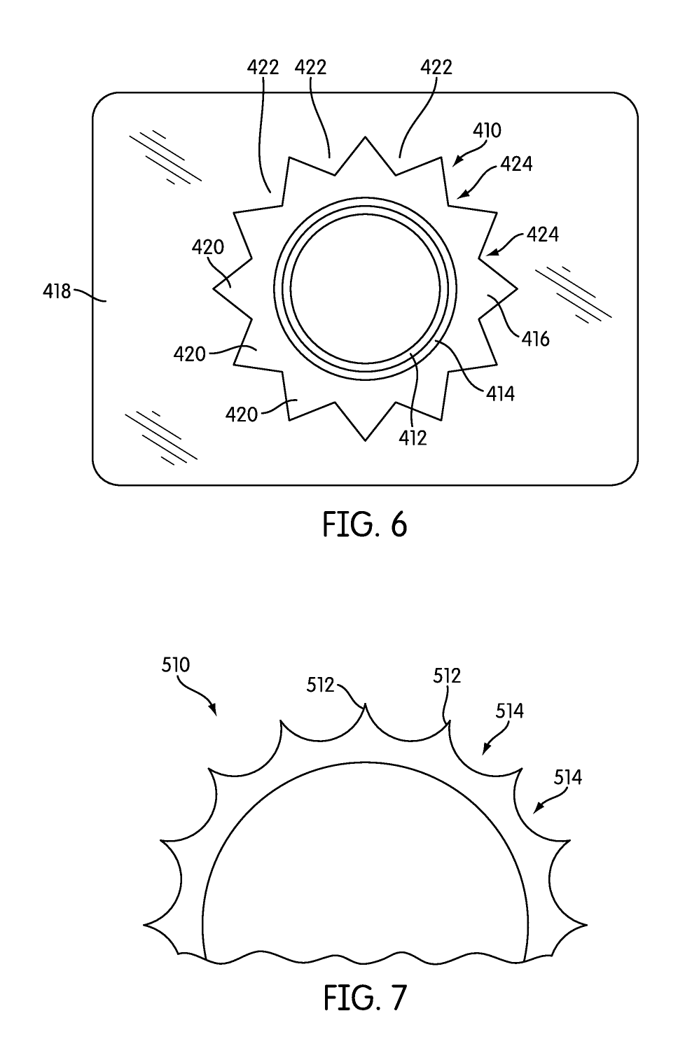

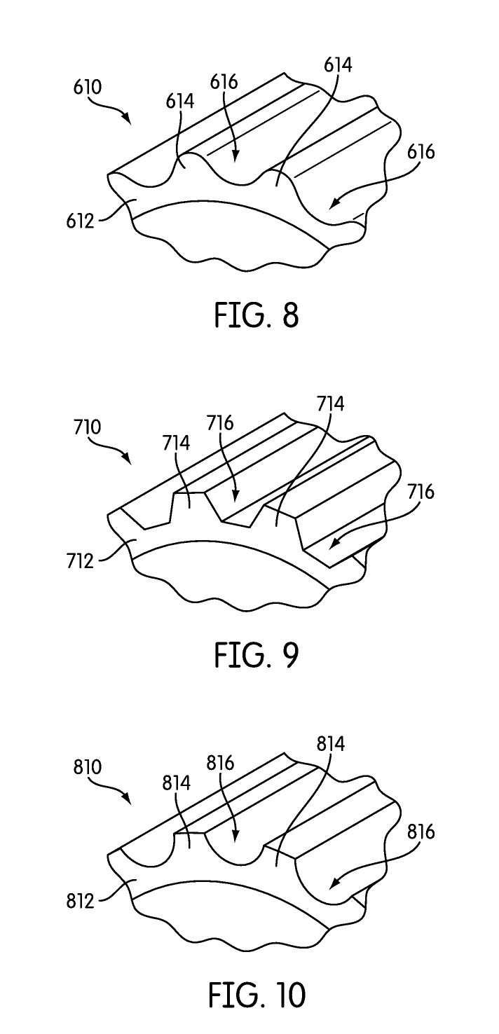

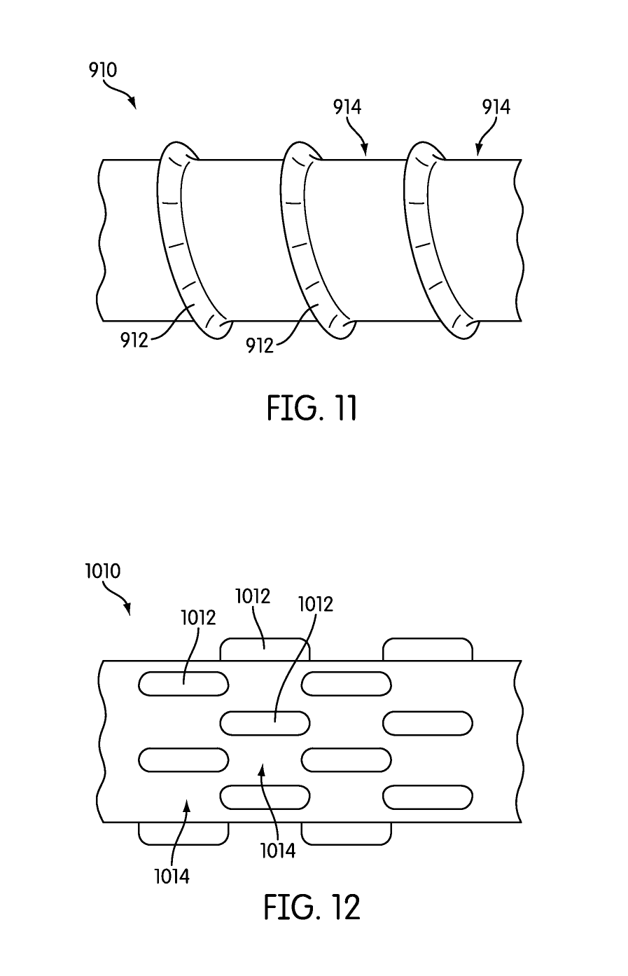

Referring to FIG. 6, a hose 410 includes an inner layer 412, reinforced layer 414, and outer layer 416, where the outer layer 416 is formed via extrusion. In some cases there may be more than one reinforced layer. The shape of the extrusion die 418 is configured to provide extensions 420. In some embodiments, fingers 422 of the extrusion die 418 are inversely contoured to match the extensions 420 of the hose 410. In contemplated embodiments, the extrusion die 418 is moved (e.g., rotated, narrowed/widened) to change the shape of the outer layer 416 as the outer layer 416 is extruded (see FIGS. 11-12). In other embodiments, the extrusion die 418 is fixed, and the shape of the extensions 420 and grooves 424 are constant along the length of the hose 410 (see FIGS. 8-10). In other embodiments, the hose 410 or layers 412, 414, 416 of the hose 410 are formed by processes other than extrusion.

Referring now to FIGS. 6-7, extensions 420, 512 of hoses 410, 510 may be pointed (e.g., spiked), and grooves 424, 514 between the respective extensions 420, 512 may be “V”-shaped (FIG. 6), “U”-shaped (FIG. 7), or otherwise shaped. A pointed extension may provide a good indication of wear because the area of the top of the extension increases as the extension is worn, where the degree of area increase is a function of the remaining height of the extension. In some embodiments, the pointed extensions form longitudinal ridges, while in other embodiments, the pointed extensions are individual spikes on the outer layer. In some embodiments, the hoses 410, 510 include about ten to twenty extensions 420, 512 and grooves 424, 514. In other embodiments, more than twenty, or less than ten extensions are used.

Referring now to FIGS. 8-10, hoses 610, 710, 810 include layers 612, 712, 812 having extensions 614, 714, 814 that may be square (FIGS. 9-10) or rounded (FIG. 8), and grooves 616, 716, 816 between the extensions 614, 714, 814 may also be square (FIG. 9) or rounded (FIGS. 8 and 10). Use of rounded grooves may provide reduced stress concentrations within the grooves (e.g., at the bottom of the groove), which may increase the life of the associated hose. In other contemplated embodiments, rounded or square extensions may be used with “V”-shaped grooves (see, e.g., grooves 424 as shown in FIG. 6). In still other embodiments, otherwise shaped extensions and grooves may be used.

Referring to FIGS. 11-12, hoses 910, 1010 include extensions 912, 1012 and grooves 914, 1014. The extensions 912, 1012 may be continuously connected to each other or may be discontinuous. The grooves 914, 1014 may also be continuously connected to each other or may be discontinuous. According to an exemplary embodiment, the extension 912 of hose 910 projects in a spiral manner around the hose 910. According to another exemplary embodiment, the extensions 1012 project as discontinuous bumps or bulges from the hose 1010. Use of diagonal, transverse, discontinuous, or otherwise contoured extensions 912, 1012 and grooves 914, 1014 may provide increased flexibility of the hoses 910, 1010, increased strength, indications of wear, and may also allow fluid to pass under the hoses 910, 1010.

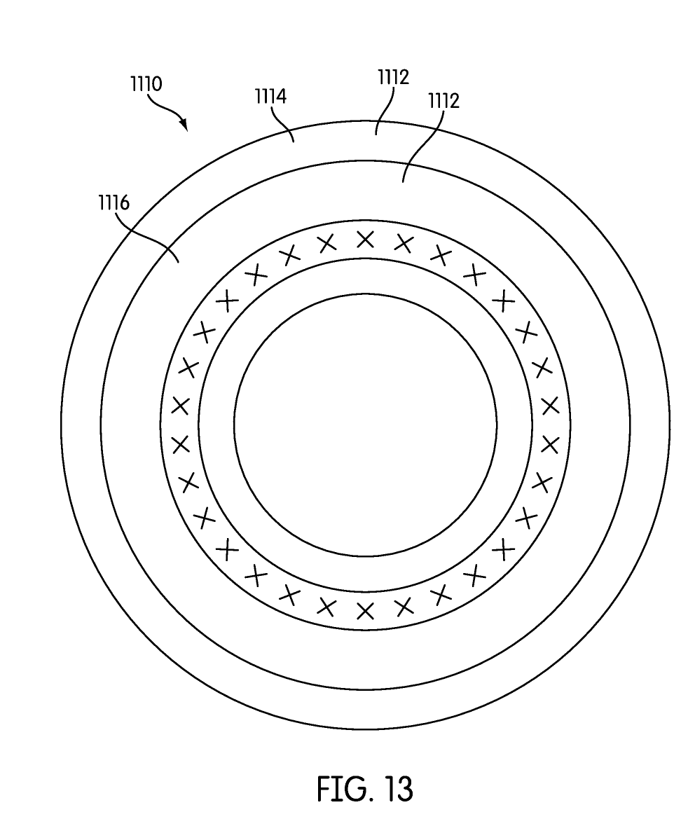

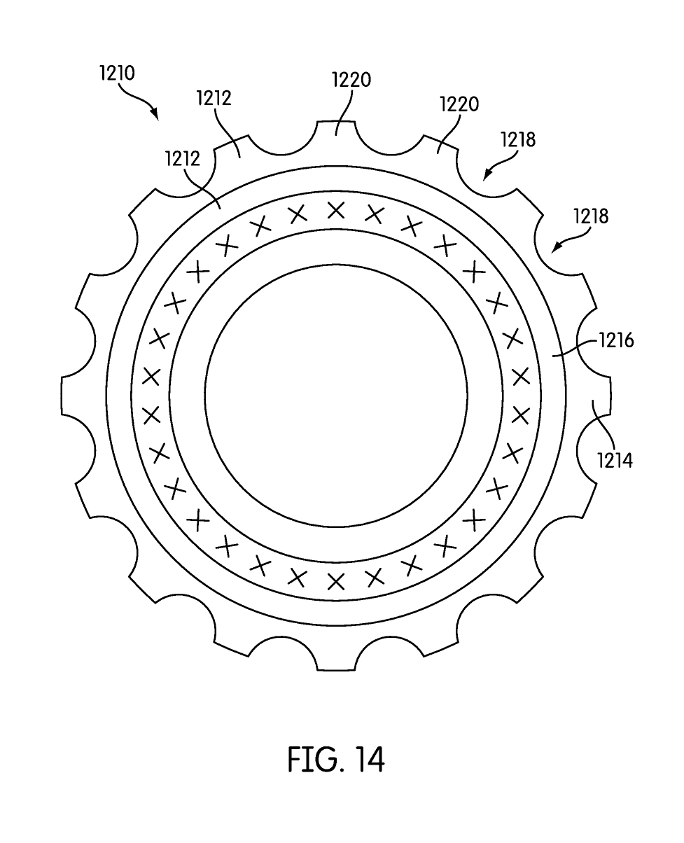

Referring now to FIGS. 13-14, hoses 1110, 1210 include outer layers 1112, 1212 formed from two separate sub-layers: a sub-layer 1114, 1214 of a first colored material and a sub-layer 1116, 1216 of a second colored material. The sub-layers 1114, 1214 and 1116, 1216 may be respectively formed via separate extrusions. In some embodiments, the first color is black and the second color visually contrasts with black, such as red, yellow, or white such that it is relatively easy to see differences in the first and second colors. As the hoses 1110, 1210 wear, the sub-layer 1114, 1214 of the first color is removed, exposing the sub-layer 1116, 1216 of the second color. Visibility of the second color provides an indication of wear of the outer layers 1112, 1212. In other contemplated embodiments, more than two colored sub-layers 1114, 1214 and 1116, 1216 are used. As shown in FIG. 14, the differently colored sub layers 1214, 1216 may be used in combination with grooves 1218 and extensions 1220.

While FIGS. 1-2 show the pressure washer 110 and hose 122 for use with the pressure washer 110, in other contemplated embodiments, hoses or features thereof disclosed herein may be used with a broad range of equipment, such as hydraulic circuits, high-pressure gas lines, or other conduits of fluid. In still other contemplated embodiments, an outer layer, such as those as disclosed herein, may be used with electrical cables or other lines that may be damaged by wear, to provide an indication of the degree of wear, reinforce the lines, increase flexibility of the lines, or for other reasons.

The construction and arrangements of the hoses, as shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A hose, comprising:
a reinforcement structure;
a layer exterior to the reinforcement structure,
wherein the layer comprises a plurality of extensions projecting outwardly such that wear of the plurality of extensions provides a visual indication of the degree of wear of the hose.

2. The hose of claim 1, wherein the plurality of extensions extend longitudinally along the length of hose.

3. The hose of claim 2, wherein the plurality of extensions are uniformly sized and spaced around the hose.

4. The hose of claim 3, wherein the plurality of extensions project outwardly from the hose by at least one-sixteenth of an inch.

5. The hose of claim 4, wherein the layer is colored a first color, and wherein the hose further comprises a second layer formed from thermoplastic and colored a second color that is different than the first color.

6. The hose of claim 4, wherein the layer further comprises U-shaped grooves between the extensions.

7. The hose of claim 6, wherein outside ends of the plurality of extensions are flat.

8. The hose of claim 7, wherein the plurality of extensions consists of at least ten but no more than twenty extensions.

9. The hose of claim 1, wherein the reinforcement structure comprises a mesh of strengthening members, wherein the layer is formed from thermoplastic, and wherein the mesh of strengthening members is formed from metal fibers.

10. The hose of claim 1, wherein the hose is configured to withstand internal pressures exceeding 1000 psi, at least in part due to the reinforcement structure.

11. A pressure washer, comprising:
a pump;
a spray gun; and
a hose configured to connect the spray gun to the pump,
wherein the hose comprises a plurality of extensions projecting outwardly from the hose such that wear of the plurality of extensions provides a visual indication of the degree of wear of the hose.

12. The hose of claim 11, wherein the plurality of extensions extend longitudinally along the length of hose.

13. The hose of claim 11, wherein the plurality of extensions are uniformly sized and spaced around the hose.

14. The hose of claim 13, wherein the hose includes a first layer that is colored a first color, wherein the first layer comprises the plurality of extensions, and wherein the hose further comprises a second layer located interior to the first layer and colored a second color that is different than the first color.

15. The hose of claim 11, wherein the plurality of extensions project outwardly from the hose by at least one-sixteenth of an inch.

16. The hose of claim 11, wherein the plurality of extensions consists of at least ten but no more than twenty extensions.

17. The hose of claim 11, wherein the hose further comprises U-shaped grooves between the extensions.

18. The hose of claim 17, wherein outside ends of the extensions are flat.

19. A method of manufacturing a hose, comprising:
providing an extrusion die; and
extruding a layer of a hose using the extrusion die, the layer comprising a plurality of extensions projecting outwardly such that wear of the plurality of extensions provides a visual indication of the degree of wear of the hose.

20. The method of claim 19, wherein the extrusion die comprises a plurality of fingers that are inversely contoured to match the plurality of extensions of the hose.
